(19) United States
(12) Patent Application Publication
(10) Pub. No.: US 2026/0259306 A1
(43) Pub. Date: Sep. 3, 2026

(54) Method for determining a flux of aerial particulates and associate electronic device

(71) Applicant: ArcelorMittal, Luxembourg (LU)

(72) Inventors: Pablo CORROCHANO DIAZ, Aviles Asturias (ES); Beatriz GONZALEZ FERNANDEZ, Aviles Asturias (ES); Jaime PEREZ ORDIERES, Aviles Asturias (ES)

(21) Appl. No.: 19/489,956

(22) PCT Filed: Jul. 2, 2024
(86) PCT No.: PCT/IB2024/056449

§ 371 Date: Dec. 4, 2025

(30) Foreign Application Priority Data
Jul. 6, 2023 (WO) PCT/IB2023/056980

(51) Int. Cl. G01S 7/481; G01S 7/483; G01S 7/497; G01S 17/95

(52) U.S. Cl. CPC G01S 7/4817; G01S 7/483; G01S 7/497; G01S 17/95

(57) ABSTRACT

A method for determining a flux of aerial particulates, the method including: s1) controlling a steerable lidar device so that the lidar device scans a control surface, by emitting several laser pulses directed along different emission axis and acquiring corresponding back-scattered optical signals; s2) processing the back-scattered optical signals to determine, along each emission axis, values of a particulate density and of a colinear wind speed at different distances from the lidar device, s3) computing a particulates flux through the control surface based on the values of the particulate density and of the colinear wind speed.

### BACKGROUND

Monitoring aerial particulates emissions from an operation area, such as an agricultural or an industrial area, is very useful for air-quality monitoring and/or to monitor processes taking place in such an area.

### SUMMARY OF THE INVENTION

Video monitoring with automatic image analysis is sometime employed to monitor industrial chimney exhaust plumes. But this technique is limited to such localised, buoyant sources, and generally does not provide a quantitative estimation of the mass of particulates emitted.

Lidar scans have also been used to provide maps of particulate density over an open-air operation area, to image the quantity of particulates present in air, above that area. Though useful, such maps provide no information, or at least very indirect information regarding a quantity of particulates emitted by that area, that is regarding the emissions themselves.

The present invention provides a method for determining a flux (φ) of aerial particulates, the method comprising:
s1) controlling a steerable lidar device (2) so that the lidar device (2) scans a control surface(S), by emitting several laser pulses directed along different emission axis (X_{j,k}) and acquiring corresponding back-scattered optical signals;
s2) processing the back-scattered optical signals to determine, along each emission axis, values of a particulate density (PM) and of a colinear wind speed (ωₘ) at different distances (dᵢ) from the lidar device (2),
s3) computing a particulates flux (φ) through the control surface(S) based on said values of the particulate density (PM) and of the colinear wind speed (ωₘ).

Basing this particulate flux determination upon wind speed values, that are derived from the lidar acquisitions, enables an accurate estimation of this flux. Indeed, wind direction and speed typically varies with time, and also possibly from one point to the other, above an open-air operation area, and so, it is beneficial to use concomitant, and co-localised measurements of the particulate density and of the wind speed (or of a component thereof), at different positions on the control surface. In particular, using local measurements of the wind speed, rather than a single-point or an average wind measurement, carried on with a cup anemometer or the like, is favourable in terms of accuracy.

Still, it is noted that computing a flux through a control surface, from data obtained during a lidar scan, is not immediate. Indeed, a back-scattered optical signal acquired by a lidar enables to determine values of the colinear wind speed ωm, but not directly values of the amplitude or of the direction of the wind speed itself, ω, which are however necessary to compute a through-surface flux of particulates carried away by air movements. The colinear wind speed in question, om, is the component of the wind speed ω parallel to the axis of emission of the laser pulse emitted by the lidar. It is sometimes called “radial wind speed” in the technical field of lidars. The control surface in question may extend over, or around, or over and around an open-air operation area. An aerial particulates emission from this open-air operation area can then be determined by computing said flux.

The control surface and the open-air operation area may in particular form together a closed or mainly closed surface (in other words, the control surface may enclose the open-air operation area). This closed or mainly closed surface delineates a volume of air that extends over the open-air operation area (volume of air which is scanned by the lidar, when it scans said control surface).

When the control surface encloses the open-air area, somehow covers up that area (i.e.: the open-air area, together with the control surface, forms a closed surface), it is necessary, for some parts of the control surface, to know the value of the vertical component of the wind speed in order to compute the particulate flux in question. And determining the vertical component of the wind speed in many different points, from lidar scans, required specific developments, as explained in the detailed description.

The present invention also provides an electronic device (10) configured to execute the following steps:
s1) controlling a steerable lidar device (2) so that the lidar device (2) scans a control surface (S), by emitting several laser pulses directed along different emission axis (X_{j,k}) and acquiring corresponding back-scattered optical signals;
s2′) receiving, from the lidar device:
   values, along each emission axis, of a particulate density (PM) and of a colinear wind speed (ωₘ) at different distances (dᵢ) from the lidar device (2), determined by the lidar device from said back-scattered optical signals; or
   data, comprising the back-scattered optical signals or derived from the back-scattered optical signals, suitable to determine values of the particulate density (PM) and of the colinear wind speed (ωₘ), along each emission axis, at different distances (dᵢ) from the lidar device (2),
s3) computing a particulate flux (φ) through the control surface(S) based on said values of the particulate density (PM) and of the colinear wind speed (ωₘ).

The present invention also provides a system (4) comprising a steerable lidar device (2) and a processing device (10), configured to execute the following steps:
s10) scanning, by the steerable lidar device (2), a control surface(S), by emitting several laser pulses directed along different emission axis (X_{j,k}) and acquiring corresponding back-scattered optical signals;
s2) processing the back-scattered optical signals, by the processing device (10) and/or the steerable lidar device (2), to determine, along each emission axis, values of a particulate density (PM) and of a colinear wind speed (ωₘ) at different distances (dᵢ) from the lidar device (2),
s3) computing a particulates flux (φ) through the control surface(S) based on said values of the particulate density (PM) and of the colinear wind speed (ωₘ).

The present invention also provides computer program comprising instructions, whose execution on a computer device (10) connected to a steerable lidar device (2) makes the computer device to execute the following steps:
s1) controlling the steerable lidar device (2) so that the lidar device (2) scans a control surface (S), by emitting several laser pulses directed along different emission axis (X_{j,k}) and acquiring corresponding back-scattered optical signals;
s2′) receiving, from the lidar device:
   values, along each emission axis, of a particulate density (PM) and of a colinear wind speed (ωₘ) at different distances (dᵢ) from the lidar device (2), determined by the lidar device from said back-scattered optical signals; or
   data, comprising the back-scattered optical signals or derived from the back-scattered optical signals, suitable to determine values of the particulate density (PM) and of the colinear wind speed (ωm) along each emission axis, at different distances (dᵢ) from the lidar device (2),
s3) computing a particulate flux (φ) through the control surface(S) based on said values of the particulate density (PM) and of the colinear wind speed (ωₘ).

In this document, the lidar device (which stand for “Light Detection And Ranging” device) is called indifferently “lidar device” or “lidar”.

### BRIEF DESCRIPTION OF THE DRAWINGS

The invention will now be described in more detail and illustrated by examples without introducing limitations, with reference to the appended figures.

FIG. 1 is a top view of tan area monitored using the instant method.

FIG. 2 represents schematically this area, in perspective, together with a control surface employed to compute the particulate flux emitted by this area.

FIG. 3 represents schematically a system employed to execute that method.

FIG. 4 represents schematically an emission axis, along which a laser pulse is emitted.

FIG. 5 represents schematically, in a perspective view, different azimuth scans carried on to scan the air over the area that is monitored.

FIG. 6 represents schematically such an azimuth scan, viewed from above.

FIG. 7 represents schematically several azimuth scans, viewed from the side.

FIG. 8 is a sequence diagram representing a sequence of steps of the instant method.

FIG. 9 represent schematically, from above, an ensemble of discrete cells, where the particulate density has been measured thanks to the lidar device, these cells intersecting the control surface.

FIG. 10 and FIG. 11 schematically represent two close, successive laser emissions employed to deduce a value of the vertical, or respectively, horizontal component of the wind speed.

FIG. 12 represent schematically, from above, an additional lateral surface, employed for a redundancy check of the method's reliability.

### DETAILED DESCIPRIPTION

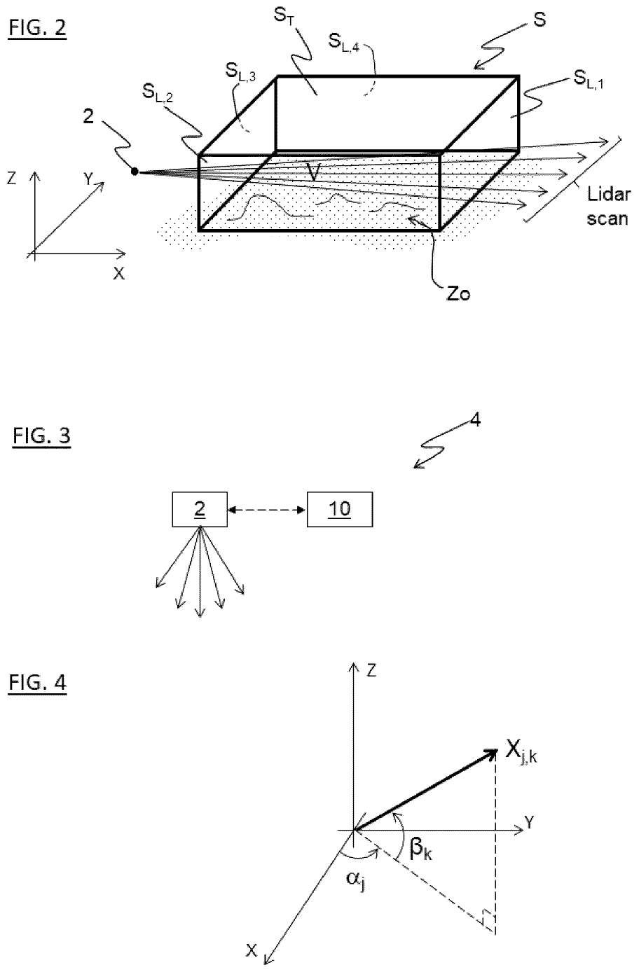

The instant method is a method for determining an aerial particulates emission from an open-air area Zo (FIG. 2), such as an industrial or mining area.

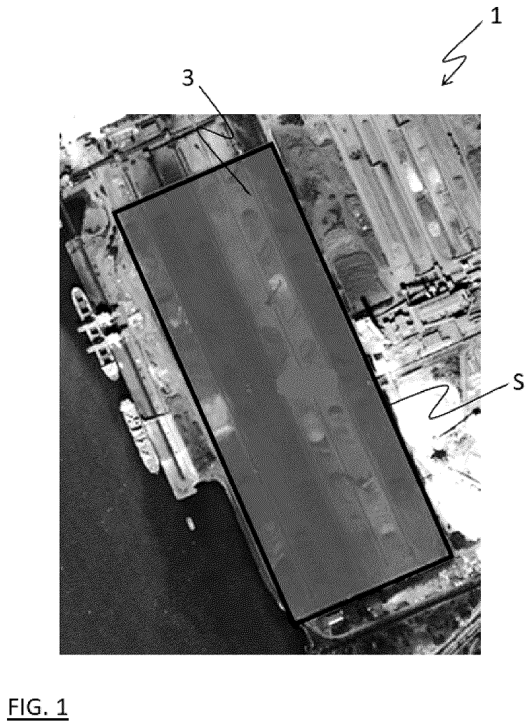

As represented in FIG. 1, the area Zo is a primary mineral yard 3, and is part of an industrial facility 1, here a steel-making plant. Different piles of mineral and coal raw materials are stored in this primary mineral yard 3. The area has different roads to allow the transport of materials in case of necessity, and different heavy machinery are also meant to do this collection and transport (reclaimers, etc.). Typically, the piles are about 10 to 20 meters high.

In other embodiments, the area Zo to be monitored may include other elements of a steel-making plant, such as a secondary mineral yard, a sintering plant, or a blast furnace facility. The area, monitored thanks to the instant method, may include just one, or more than one of these elements. In still another embodiment, the area in question encompasses an open-pit mine, or another kind of open-air operation area. More generally, the expression open-air area designates a piece of land (a piece of ground), with the installations or structured present on this piece of land if any.

To determine the amount of particulates emitted by the open-air area Zo, the following steps are executed:
s1) controlling a steerable lidar device 2, so that the lidar device 2 scans a zone V located over said area Zo (see FIG. 2), by emitting several laser pulses directed along different emission axis and acquiring corresponding back-scattered optical signals;
s2) processing the back-scattered optical signals to determine, along each emission axis, values of a particulate density PM and of a colinear wind speed Om at different distances dᵢ from the lidar device 2,
s3) determining an aerial particulates emission from the area Zo by computing a particulate flux φ through a control surface S enclosing the area Zo (see FIG. 2), the particulate flux φ being computed based on the values of the particulate density PM and of the colinear wind speed ωₘ determined from the back-scattered optical signals acquired by the lidar device 2.

In the following description, the particulate flux φ is a mass flux, corresponding to the overall mass of the particulates traversing the control surface S per unit time. Still, in other embodiments, the particulate flux may correspond to a number of particulates (particulates that are within a given size range, for instance) or to a volume of particulate traversing the control surface per unit time.

The control surface S is the boundary (in other words the envelope) of a volume of air V that extends over the area Zo, from this area Zo. The control surface S extends from the ground, over the area Zo, and to the ground again (it somehow covers up the area Zo). The open-air area Zo, together with the control surface S, forms a closed surface (enclosing completely the volume V).

In the example here described, with reference to the figures, the control surface S comprises of:
a top surface S_{T} which is horizontal (possibly with a slight deviation, for instance horizontal within 2 degrees or less),
and a lateral surface S_{L} which surrounds the area Zo and which is vertical (possibly with a slight deviation, for instance vertical within 2 degrees or less).

The lateral surface S_{L} surrounds the area Zo in that it extends all around the area Zo, enclosing, somehow girdling that area.

Using such a control surface, composed of a horizontal part S_{T} and a vertical, lateral part S_{L}, is beneficial. Indeed, for deriving a vertical wind speed component, in many different points of a control surface, from lidar scans, a horizontal surface turns out to be well adapted, as will be described later. In addition, there are two typical sources of aerial particulates emissions, on such an open-air operation area: buoyant sources (like sinter cooler exhaust, or aeration from building roofs), and diffuse open sources (like wind erosion, road emissions, or low height handling). For buoyant sources, the particulates emitted have enough impulse to be lifted and transported away large distances from their source, and it is expected that most of such emissions crosses the top surface S_{T}. While for diffuse sources, it is expected that most of the emissions crosses the lateral surface S_{L}. So, the horizontal plus vertical structure of the control surface S enables to access additional information regarding the nature of the emissions.

As represented in the figures, the area Zo has a rectangular boundary, and the control surface S has thus a parallelepipedal shape. The top surface S_{T} is rectangular, and the lateral surface S_{L} is composed of four lateral flat faces S_{L,1}, S_{L,2}, S_{L,3} and S_{L,4} (FIG. 2). Still, the control surface S could have a different shape. For instance, if the open-air area is circular, then the top surface will be circular too and the lateral surface will have the shape of the lateral surface of a cylinder. In the above examples, the open-air area together with the control surface form a completely closed surface. Still, in some cases, they may form together a surface that is mainly closed, meaning it is closed except for one or more openings whose total area is below 50%, or below 20%, or even below 10% of the total area of the control surface S. Such a case, with a not entirely enclosing control surface, may happen when there is, for some of the emission axis, an obstacle such as a chimney on the emission axis considered, which prevents making measurements for some positions, behind the obstacle. In such a case, the instant method can still be applied, but is slightly less accurate than when the control surface completely encloses the open-air area to be monitored. In some cases, the control surface may also not go entirely to the ground (it may stop above the ground), leading also to a not entirely enclosing control surface. In this case also, the instant method can still be applied.

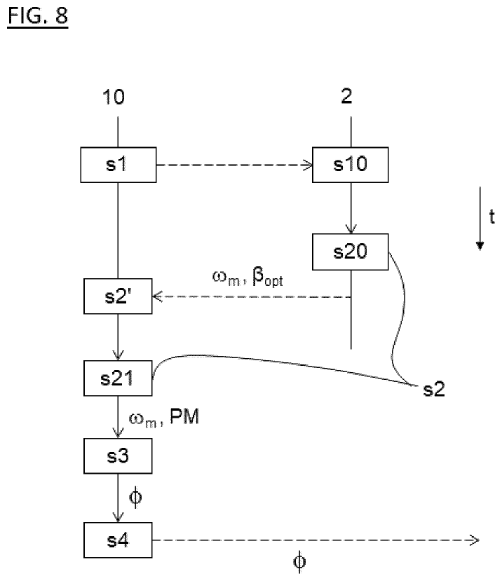

The complete scan and computing process, which enables to determine the particulate flux φ, is achieved by a system 4 comprising the lidar device 2 and a processing device 10 (FIG. 3). The processing device 10 is configured, for instance programmed, to execute at least the following steps (FIG. 8):
step s1 (controlling the lidar 2, so that it scans the air over the area Zo),
step s2′: receiving, from the lidar device 2:
   the backscattered optical signals acquired during said scan, and/or
   data, derived from said signals and suitable to determine values of the particulate density PM and of the colinear wind speed ωₘ along the different emission axis, and/or
   values of the particulate density PM and of the colinear wind speed ωm along the different emission axis, determined directly by the lidar device,
step s3.

Step s2, of processing the backscattered optical signals to determine values of the particulate density PM and of the colinear wind speed om, may be executed either by the lidar device 2; or by the processing device 10; or both by the lidar device (for a part of that processing) and by the processing device (for the remaining part of that processing).

In the embodiment of FIG. 3, the lidar device 2 is a stand-alone device, distinct and possibly remote from the processing device 10. The lidar device 2 and the processing device are connected together, using either a wire or wireless connection, and possibly through a network. They can thus exchange data and instructions. The processing device 10 may comprise at least a processor and a memory. It may take the form of a stand-alone computer, electronic unit or server. But it could also be implemented in a distributed manner (somehow “virtually”), using so-called “cloud” resources (computing and storing resources distributed among distinct physical systems in a network).

In alternative embodiments, instead of being distinct from the lidar device, the processing device could be integrated to the lidar device 2 (i.e.: be part of it).

The different steps of the method are now described in more detail.

### Step 1

In step s1, the processing device 10 controls the lidar device 2 so that the lidar device scans the zone V (the air) located over the area Zo, to scan the control surface S. To this end, the processing device 10 sends scanning instructions or scanning parameters (in step s1) to the lidar device 2, which then executes the scan (in step s10, see FIG. 8). The characteristics of this scan are now described in more detail.

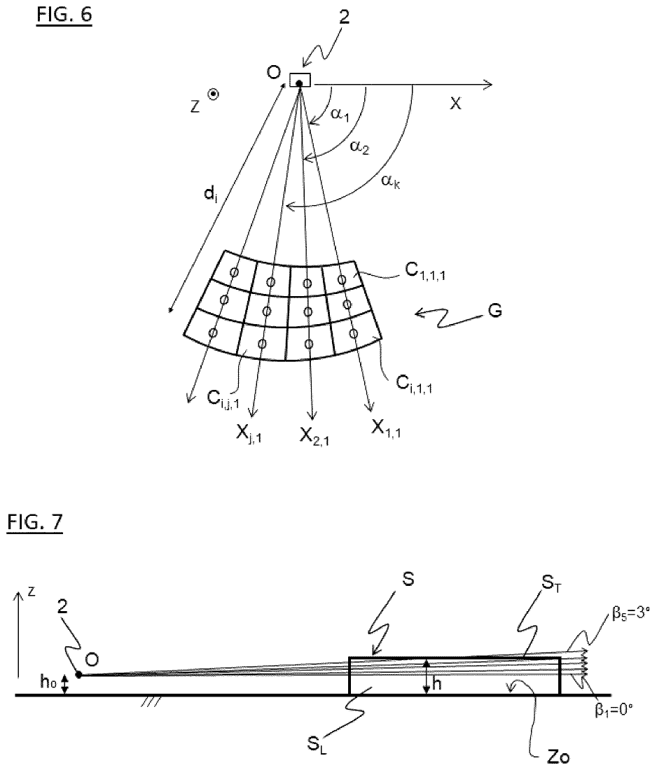

During this scan, the lidar 2 emits several laser pulses, directed respectively along different emission axis X_{j,k} (see FIGS. 2 and 6 for instance). For each laser pulse emitted, the lidar acquires a corresponding back-scattered optical signal, that is an optical signal scattered back at the lidar in response to the emission of that laser pulse. This optical signal is scattered back by the air and particulates located on the path of that laser pulse.

For each laser pulse, the direction of the emission axis X_{j,k} of the pulse is specified by an azimuth αⱼ and an elevation βₖ, as shown in FIG. 4. In FIG. 4, and in the other figures, three axis x, y and z are represented. Axes x, y, and z are perpendicular to each other. Axis z is vertical (and ascendent). Axis x corresponds to a reference, fixed horizontal direction (for instance, axis x points to the North). The azimuth αⱼ is the angle between axis x and the projection of the emission axis X_{j,k} onto the horizontal plane x,y.

The scan, commanded in step s1, comprises at least a first “azimuth scan” (a “horizontal” scan, in some way). By “azimuth scan”, it is meant a scan carried on by varying the azimuth but keeping a fixed elevation. Such an “azimuth scan” is a scan in the so-called Plan Position Indicator (PPI) mode (the lidar holds its elevation angle constant but varies its azimuth angle). The elevation Bk is the angle between a horizontal plane and the emission axis X_{j,k} considered. In this document, all the elevations considered are angular elevations (not heights).

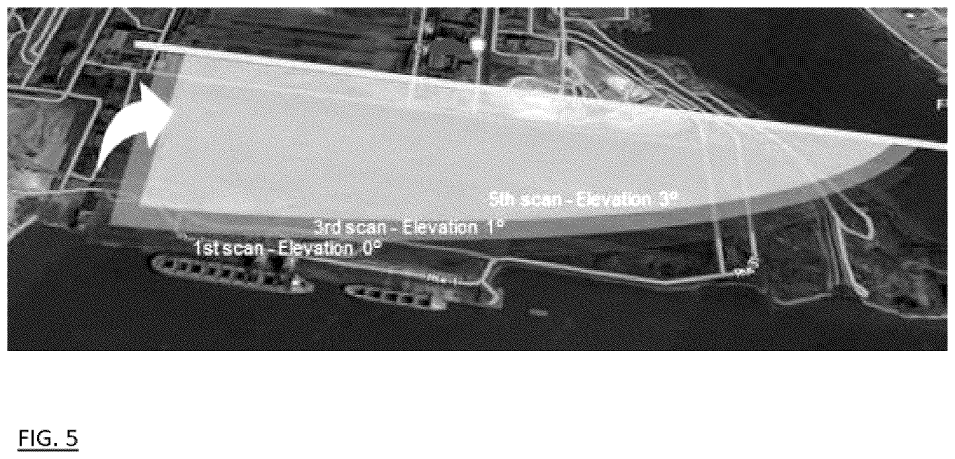

So, in step s1, the lidar is controlled so that some of the laser pulses are emitted with respective azimuths α₁, α₂, . . . , α_{J} as that are different from one another, but with a same elevation, noted β₁. These laser pulses form a first set of laser pulses, or, in other words, a first scan (namely, a first “azimuth scan”). FIG. 5 shows the zone covered by this first scan (zone labelled as “first scan” in FIG. 5), in a case where β₁=0°. This first scan is carried on so that the corresponding ensemble of emission axis, that is X_{j,k=1}j=1 . . . J, covers entirely the area to be monitored, Zo. In other words, the emission axis X_{j,k=1}, j=1 . . . J, are distributed over a zone (looking like an angular sector—see FIG. 5) that covers entirely the area Zo. The zone encompassed between the emission axis X_{j=1,k=1} and the emission axis X_{j=J,k=1} (axis corresponding to the minimum, and to the maximum azimuths, in this first scan) covers the whole area Zo (i.e.: is superposed at least to the whole area Zo). The number of different azimuths in this first “azimuth scan”, noted J, is for example higher than 40, or even higher than 90. The angular step dα between two adjacent azimuths of this scan (step which is not necessarily constant) is for example from 0.1 to 3 degrees, or even from 0.1 to 1 degree.

The complete scan achieved by the lidar 2 may also comprise, like here, one or more additional “azimuth scans”, achieved for elevations β₂, . . . βₖ, . . . β_{K}, that are different from β₁, and different from each other.

In the examples of FIGS. 5 and 7, the number of “azimuth scans”, K, is equal to 5, and the different elevations are: β₁=0°, β₂=0.5°, β₃=1°, β₄=2°, and β₅=3°. FIG. 7 represents schematically the zones (having each the shape of an angular sector) scanned respectively during the first (β=β₁), third (β=β₃) and fifth (β=β₅) “azimuth scans”.

K is, for example, equal or higher than 3. It may be from 3 to 10. The angular step dβ between two successive elevations (which is not necessarily constant) is for example from 0.3 to 5 degrees, or even from 0.5 to 3 degrees. The elevations employed may be either positive (upward scanning) or negative (downwards scanning).

Anyhow, in the embodiments described here, among the different elevations β₁, . . . β_{K}, at least one elevation is close to zero, meaning that its absolute value is below 10 degrees, or even below 5, or below 2 degrees. And at least one other elevation is close to that elevation, with an angular difference dB that is below 10 degrees, or even below 5, or below 2 degrees. These features are favorable to determine values of the vertical component of the wind speed, from the lidar scans, as detailed further below. Having at least one elevation close to zero also facilitates the computation of the flux through the lateral surface S_{L}. The absolute values of the different elevations β₁, . . . β_{K} are preferably each below 20 degrees, or even below 10 degrees.

Here, the set of azimuths for the laser pulses emissions, α₁, . . . , α_{J}, is the same for the different “azimuth scans”: the same set of azimuths is employed for the azimuth scan carried on with β=β₁, for the azimuth scan carried on with β=β₂, and so on.

### Step s2

As represented in FIG. 8, step 2, which comprises processing the backscattered optical signals, can be executed partially by the lidar device 2, in step s20, and partially by the processing device 10, in step s21.

The backscattered optical signals are acquired using a light sensor of the lidar device, such as a photodiode or a photomultiplier tube. They may each represent a back-scattered optical power, as a function of time (as a function of a way-and-back travel time, for light, which is a kind of echo-time). They may also take the form of a carrier-to-noise ratio, as a function of the time of flight, or of a signal-to-noise ratio SNR, as a function of the time of flight (the noise being for instance defined as the standard deviation of the optical signal, within a limited time window).

In step s20, the lidar device determines values of a radial backscatter coefficient βₒₚₜ (expressed for instance in meter⁻¹ steradian⁻¹), and of the colinear wind speed ωₘ, at different distances dᵢ from the lidar 2 (in practice, for different times, distributed within the total duration of each backscattered optical signal). The values of the colinear wind speed om may be determined by intra-signal cross-correlation. The values of the radial backscatter coefficient βₒₚₜ are determined here from the SNR of the backscattered optical signal, using the classical Klett LiDAR inversion method.

The distances dᵢ mentioned above (related to the measurement range and accuracy of the lidar) may be from 20 m to 2 km. The gap between two successive distances dᵢ may be from 5 to 200 meters in particular when using the technique of overlapping pulses to increase the LIDAR resolution. The total number I of distance samples dᵢ, i=1 . . . 1, is typically from 25 to 500.

Then, in step s2′, the processing unit 10 receives the values of ωₘ and βₒₚₜ, transmitted by the lidar.

In step s21, the processing unit converts each value of βₒₚₜ into a value of particulate density PM. To this end, a conversion coefficient, equation or algorithm, stored in a memory of the processing device, is employed. Here, the particulate density PM is a mass density, expressed for instance in micrograms per cube meter. Here, the conversion from βₒₚₜ to PM is such that the values of PM are mass densities representing the mass of all particulates, with a dimension below 10 microns (such fine particulates being usually called “PM₁₀” in this technical domain), within a given volume of air. This conversion is not limited exclusively to PM10 particles, being possible to determine other fractions of particulates with diameters of environmental interest (e.g. particles with aerodynamic diameter below 2.5 microns or PM2.5)

By particulates, it is meant atmospheric aerosol particles, such as sand suspensions, mineral suspensions, dust, for instance quarry dust, mineral processing dust, wind-erosion dust, combustion residues, smoke components, etc.

Regarding the conversion, from βₒₚₜ to PM, the instant method may comprise a preliminary calibration step (carried on before step s1), during which the relationship between βₒₚₜ and PM is determined.

This calibration step is for instance achieved by acquiring a back-scattered optical signal for a given fixed emission axis, several times successively, at different instants, and acquiring jointly particulate density values measured using a particulate sensor (such as an air sampling pump, or an optical particulates counter). The particulate sensor is distinct from the lidar and achieves particulate density measurements at a fixed position. This position is selected so as to be near the fixed emission axis of the lidar.

For each back-scattered optical signal acquired, a value of βₒₚₜ, at a distance corresponding to that fixed position of measurement, is determined. Then, the time series comprising the several successive values of βₒₚₜ is correlated with the time series comprising the several successive values of particulate density PM acquired by the particulate sensor, to determine the relationship between βₒₚₜ and PM (for instance by linear regression). The βₒₚₜ and PM time series may be temporally aligned, one with respect to the other, before determining the relationship in question. To the end, a possible temporal offset between the two signals is determined (and then compensated for) by identifying a maximum in the temporal correlation function of βₒₚₜ with respect to PM. The fixed position, at which the βₒₚₜ measurements, and the direct PM measurements are done, is preferably substantially above the ground (position higher than 10, or even 20 meters above the ground), and away (100 m away or more) from any localized, buoyant source. This fixed position, for the calibration, is preferably within the area Zo to be monitored, or in its vicinity.

It may be noted that alternatives, different from the one presented above, are possible regarding the distribution of the determination step s2, between the lidar device 2 and the processing device 10. For instance, the lidar device may transfer directly the back-scattered optical signals (optical power as a function of time, or SNR as function of time) to the processing unit, the processing unit carrying on the whole processing of these signals, to determine the values of ωₘ and PM. Or, the lidar device may transfer to the processing device values of om and the back-scattered optical signals, the processing device then determining βₒₚₜ, and then PM from the back-scattered optical signals. Or the lidar device 2 may achieve the whole processing of the back-scattered optical signals, and then transmit to the processing unit 10 the values of ωₘ and PM.

### Step s3

In the example described here, to compute the particulate flux φ through the control surface S, the zone V scanned by the lidar 2 is discretized into a grid G of cells C_{i,j,k} (FIG. 6), and elemental fluxes φ, corresponding to fluxes at the cells level, are computed and then summed-up to obtain the total particulate flux φ.

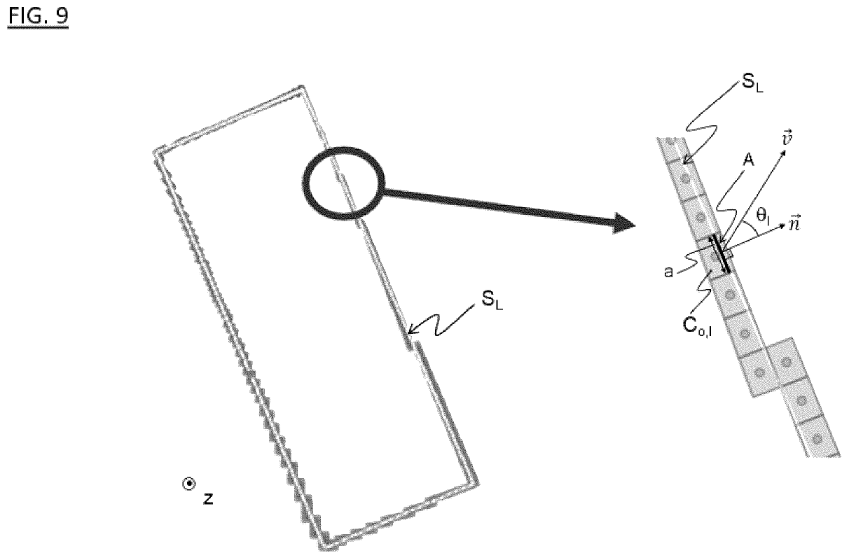

More specifically, step s3 comprises the following steps, here:
building numerically the grid G comprising of the cells C_{i,j,k} that are centered on the different emission axis X_{j,k} and that are located at the different measurement distances dᵢ from the lidar device 2; The cells of the grid are contiguous one to the another,
identifying frontier cells C_{o,I}, which are the cells C_{i,j,k} of the grid G that intersect the control surface S (FIG. 9),
computing the elemental flux φ for each frontier cell C_{o,I}, the elemental flux being a particulate flux through a portion A of control surface S intersected by the frontier cell considered,
computing the mass flux φ through the control surface S by summing the elemental mass fluxes φ together.

Building numerically the grid G means determining the position of the boundaries (or of the edges or vertices of that boundary) for each cell C_{i,j,k} and/or determining the position of the cell's centres.

As can be seen in FIG. 6, each cell C_{i,j,k} is centered on a point that is at the distance dᵢ from the lidar's position O, and that is on the emission axis X_{j,k}. The cells are contiguous to each other. The boundary between two adjacent cells is located halfway between the centers of these two cells. FIG. 6 is a view from above of just one “azimuth scan”; so, it shows just one layer of cells of the grid G (namely the 2D layer C_{i,j,k=1}, corresponding to elevation β₁). But the grid G is a three-dimensional grid, in this embodiment, and comprises several such layers superimposed to each other.

Regarding the vertical extension of the cells, the area of the cells are extended in the same proportion to the difference in height between the two consecutive scans considered. For the lowest layer of cells (here, for the layer of cells C_{i,j,k=1}), each cell may extend downward until it reaches the ground, possibly using interpolation methods to provide an accurate prediction of the concentration near the ground level (see FIG. 7).

Due to the radial nature of the lidar scan, the grid G has a radial-like structure rather than a Cartesian structure. The surfaces delineating each cell C_{i,j,k} may, like here, be each either parallel or perpendicular to the emission axis considered, X_{j,k}.

As above mentioned, the frontier cells C_{o,I} are the cells of the grid that intersect the control surface S. The frontier cells C_{o,I} are labelled with an integer I, from 1 to L. Some of the frontier cells are cells that intersect the lateral surface S_{L} (some of these ‘lateral’ frontier cells are represented in FIG. 9), while other frontier cells are cells of the grid intersecting the top surface S_{T}.

Here, for the frontier cells C_{o,I} intersecting the lateral surface S_{L}, each elemental flux φ is computed according to equation eqn 1 below:

$${φ}_{l} = {PM}_{l} \cdot A \cdot {v}_{l} \cdot cos ( {θ}_{l} ) \qquad ( eqn 1 )$$

where:
   PM_{I} is the value of the particulate density in the frontier cell C_{o,I} considered,
   A is the area of the portion of the lateral surface S_{L} that is intersected by the frontier cell C_{o,I} considered (see FIG. 9),
   v_{I} is the amplitude ∥\vec{v}∥ of the horizontal component v of the wind speed \vec{ω} at the frontier cell C_{o,I} considered,
and θ_{I} is the angle between: a unit vector \vec{n} perpendicular to the lateral surface S_{L} (at the frontier cell C_{o,I}) considered, and the horizontal component \vec{v} of the wind speed \vec{ω}.

For the frontier cells C_{o,I} intersecting the top surface S_{T}, each elemental flux φ is computed according to equation eqn 2 below:

$${φ}_{l} = {PM}_{l} \cdot A \cdot {u}_{l} \qquad ( eqn 2 )$$

where:
   PM_{I} is the value of the particulate density in the frontier cell C_{o,I} considered,
   A is the area of the portion of the top surface S_{T} that is intersected by the frontier cell C_{o,I} considered (this elemental area A is computed, frontier cell by frontier cell, during step s3),
   and uₗ is the value of the vertical component u of the wind speed ω at the frontier cell C_{o,I} considered.

Two components of the wind speed \vec{ω} are considered here: the horizontal component \vec{v}, which is parallel to the horizontal (x,y) plane, and the vertical component u, which is parallel to the vertical axis z. The wind speed \vec{ω} thus reads: \vec{ω}=\vec{v}+\vec{u}. \vec{e}_{z} where \vec{e}_{z} is the unit vector directed as axis z. By wind speed, it is meant the velocity of air (at the position considered), whatever the cause of this movement of air (either meteorological, or arising from human activities, gas exhausts, material displacements or else).

The total particulate flux φ is computed by summing the elemental fluxes φ, both for the frontier cells of the top surface S_{T} and for those of the lateral surface S_{L}. The total number of frontier cells is noted L and φ reads:

$$f = {\sum }_{l = 1}^{L} {φ}_{l} .$$

In some embodiments, the particulate flux through the lateral surface S_{L} is computed taking into account just one layer of cells (even if the grid G comprises two or more layers of cells), and considering that the element area A (in eqn 1) is equal to h, a, where h is the height of the lateral surface S_{L} (see FIG. 7), and where a is the length of the lateral surface S_{L} intersected by the frontier cell C_{o,I}, when in a horizontal cross-section (see FIG. 9). In other words, for these embodiments, the computation of the lateral flux is carried on just as if there were just one cell (of height h), in the vertical direction.

As presented above, the elemental fluxes qi are calculated from the vertical component u of the wind speed \vec{ω}, or from its horizontal component projected on vector n (that is, from \vec{v}·\vec{n}=v. cos(θ)). But the wind speed component that is directly deduced from the lidar scan is the colinear, or so-called radial wind speed ωₘ=\vec{ω}·\vec{e}_{scan} (where \vec{e}_{scan} is the unit-vector for the emission axis), not the vertical or horizontal component of the wind speed.

To derive the vertical component u of the wind speed \vec{w}, from measurements of the colinear wind speed ωₘ, the following technique is then employed: a value of a vertical component u of the wind speed is determined from at least a first value ω_{m,1} and a second value ω_{m,2} of the colinear wind speed ωₘ, obtained respectively for two different elevations, for instance for the first and second elevations β₁ and β₂ presented above. Possibly, more than two values of the colinear wind speed ωₘ, corresponding respectively to more than two different elevations, could be taken into account to determine a value of u.

Anyhow, at least one of the elevations in question (β₁ for instance) is close to zero, for instance below 10 degrees, or even below 5, or below 2 degrees. The difference between the two elevations in question (β₁ and β₂ for instance) is small, for instance below 10 degrees, or even below 5, or below 2 degrees. In such conditions, the value u_{I} of the vertical component u can be calculated, to a good approximation, as:

$${u}_{l} \approx ( {w}_{m , 2} - {w}_{m , 1} ) / ( {β}_{2} - {β}_{1} ) \qquad ( eqn 3 )$$

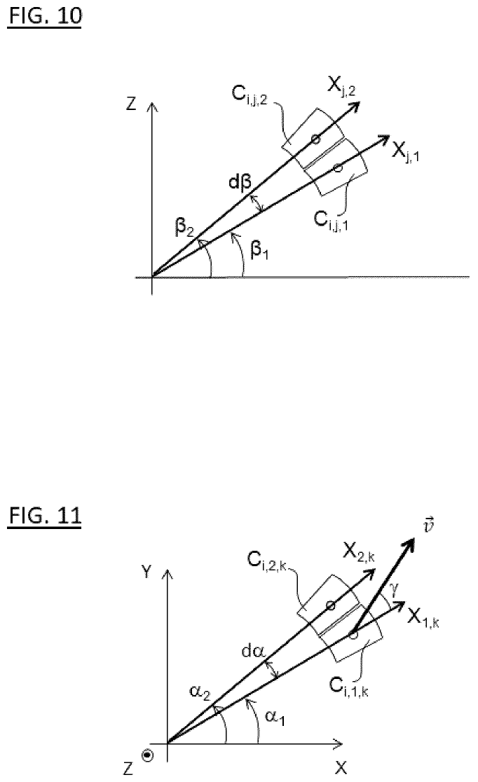

The corresponding situation is represented in FIG. 10. The two colinear wind speed ω_{m,1} and ω_{m,2} are measurements, respectively at the position of the cell C_{i,j,k=1} and at the position of the cell C_{i,j,k=2}. That is: both at the same distance dᵢ and for the same azimuth αⱼ, but for the elevation β₁ for ω_{m,1}, and for the elevation β₂=β₁+dβ for ω_{m,2}.

Generally, ωₘ reads ωₘ=\vec{ω}·\vec{e}_{scan}=v₀·cos(β)+u·sin(β) where β is the elevation and where vₒ is the component of v comprised in the plane (\vec{e}_{z}, \vec{e}_{scan}).

As dβ is small, the wind speed \vec{ω} is considered to be the same in these two close, adjacent cells. And so, the values of vₒ and u are considered to be the same, for the two measurements ω_{m,1} and ω_{m,2}. So, ω_{m,2} reads:

$${w}_{m , 2} = {v}_{o} \cdot cos ( {β}_{2} ) + u \cdot sin ( {β}_{2} ) = {v}_{o} \cdot cos ( {β}_{1} + d β ) + u \cdot sin ( {β}_{1} + d β ) \approx {v}_{o} \cdot cos ( {β}_{1} ) - {v}_{o} \cdot cos ( {β}_{1} ) \frac{d {β}^{2}}{2} - {v}_{o} \cdot sin ( {β}_{1} ) d β + u \cdot sin ( {β}_{1} ) + u \cdot d β$$

as dβ and β₁ are small compared to 1.

So,

$${w}_{m , 2} \approx {w}_{m , 1} + u \cdot d β - {v}_{o} \cdot cos ( {β}_{1} ) \frac{d {β}^{2}}{2} - {v}_{o} \cdot sin ( {β}_{1} ) d β .$$

But vₒ·dβ and vₒ·sin(β₁) are each small compared to u, in practice. Indeed, for u=1 m/s, for example, and vₒ=20 m/s (which would be very high, in practice, considering that u=1 m/s only), with the exemplary values above, of β₁=0° and dβ=0.5°, one gets vₒ·sin(β₁)=0«1 m/s and vₒ·dβ=0.17 m/s«1 m/s.

And so w_{m,2}≈w_{m,1}+u·dβ, that is:

$${u}_{l} \approx ( {w}_{m , 2} - {w}_{m , 1} ) / ( {β}_{2} - {β}_{1} ) \qquad ( eqn 3 )$$

It is noted that a relationship, between u and the two or more values of the colinear wind speed (measured for two or more different elevations), different from eqn 3 (and possibly more elaborate) could be employed, in alternative embodiments, to derive values of u from measurements of the colinear wind speed. The value of u could also be determined from the two or more values of the colinear wind speed (measured for two or more different elevations) using a statistical analysis method. For instance by adjusting the value of u so that an expected, theoretical variation of ωₘ(β), fits the measurements of ωₘ(β). Such a fitting method leads to the equations (3) to (5) of the following article, which could be employed alternatively to eqn3 above: “Validating precision estimates in horizontal wind measurements from a Doppler lidar”, Rob K. Newsom et al., Atmos. Meas. Tech., 10, 1229-1240, 2017.

In a partially similar way, the horizontal component v of the wind speed ω can be derived from two or more measurements of the colinear wind speed ωm, obtained respectively for two or more different azimuths.

An example for such a derivation of the amplitude and direction of, from two such measurements ω′_{m,1} and ω′_{m,2} is represented in FIG. 11. The two colinear wind speed ω′_{m,1} and ω′_{m,2} are measurements, respectively at the position of the cell C_{i,j=1,k} and at the position of the cell C_{i,j=2,k}. That is: both at the same distance dᵢ and for the same elevation Bk, but with the azimuth α₁ for ω′_{m,1} and with the azimuth α₂=α₁+dα for ω′_{m,2}. Here, βₖ=0°, to simplify the explanations. The angle between \vec{v} and the emission axis X_{j=1,k} is noted γ. As da is small, \vec{v} is considered to be the same in these two close, adjacent cells. So, ω′_{m,1} reads w′_{m,1}=v·cos(γ) while w′_{m,2}=v·cos(γ−dα)≈w′_{m,2}+v·sin(γ)·dα, as dα«1. Equations enq4 and eqn 5 below then enables to derive both the amplitude v and the direction γ of \vec{v}:

$${w}_{m , 1}^{′} = v \cdot cos ( γ ) \qquad ( eqn 4 )$$

$$( {w}_{m , 2}^{′} - {w}_{m , 1}^{′} ) / ( {α}_{1} - {α}_{2} ) \approx v \cdot sin ( γ ) \qquad ( eqn 5 )$$

It is noted that relationships different from eqn 4 and 5 could be employed, to derive the components of \vec{v} from two or more values of the colinear wind speed. The components of \vec{v} could also be determined from the two or more values of the colinear wind speed using a statistical analysis method, for instance using the method presented in the article by Newsom et al. above mentioned. Besides, additional processing operations may be applied to the wind speed components, like filtering (in particular smoothing of spatial and/or temporal variations) or suppression of outliers. Besides, here, a local value of the wind speed is used to compute each elemental flux.

### Step s4

In step s4, the processing unit 10 outputs the particulate flux φ determined in step s3. The particulate flux φ may be output by transmitting it to a human-computer interface such as a screen, to enable an operator to monitor that flux. It may also be output by transmitting it to a database recording the value of the particulate flux φ over time.

### Validation

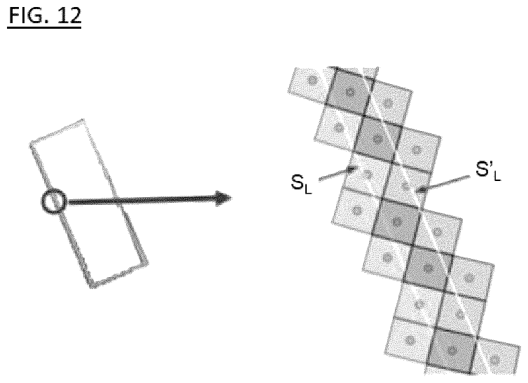

To assess the reliability of the method presented above, a first test has been carried on, using an alternative control surface S′, is identical to the control surface S except that it is slightly shifted laterally (FIG. 12). The top surface of both S and S′ are identical. The lateral surface S′_{L} of S′ is slightly shifted compared to S_{L}, by a distance that is typically the dimension of one or two cells of the grid. Then, based on the same lidar acquisitions, the particulate flux φ is computed, both using S, and using S′ as a control surface. In practice, no significant difference (less than 5% of the total value) was found between these two redundant calculations.

Comparisons were also carried on between theorical estimations of the particulate flux φ, and the values of φ measured using the lidar technique presented above.

A first test was carried on for the primary mineral yard 3 of FIG. 1. In this first test, the lidar height hₒ (see FIG. 7) was 20 meters, and the lidar scan was the one of FIGS. 5 and 7. The theoretical estimations were carried on based on the prescriptions of the “WRAP Fugitive Dust Handbook” (in particular chap. 9 of that handbook) by Countess Environmental, 4001 Whitesail Circle, Westlake Village, CA 91361 (2006). Surveys were carried on for a period of three months, during which rain and wind conditions varied substantially. Table 1 summarizes the corresponding results. In table 1, values of the particulate flux, corresponding to averages over one month, are provided, both for the theoretical estimations and for the lidar measurements. These values are in arbitrary units (and they correspond to a mass per unit time).

TABLE 1
Primary mineral yard measurements

| Method | Month 1 | Month 2 | Month 3 |
|---|---|---|---|
| Theoretical estimation | 6.5 | 6.7 | 11.2 |
| Lidar-based measurement | 4.63 | 5.75 | 15.97 |

As can be seen in table 1, the lidar-based result are in rather good agreement (approximately within 30%) with the theoretical estimates, which confirms the reliability of the lidar-based measurement method. Still, compared to theoretical estimates, the lidar-based measurements provide much detailed information regarding the temporal variations of the emissions. Besides, it is considered as more reliable, as all possible causes of variation of the flux are directly taken into account, since the flux is directly measured. While some causes of emission might be forgotten, in the theoretical estimation (for instance the number of times that the material in a pile is disturbed—consumed, reformed, etc—has a strong influence on the result-so, should an operation on a pile be forgotten, in the theoretical estimation, then the result will be substantially impaired), while the lidar-measurement are immune to such errors.

Tests have also been carried on for areas comprising industrial installations. A test was carried on for an area including a sintering plant (table 2), and for an area including a blast furnace (table 3). The quantities represented are the same as in table 1. For these two cases, the theoretical estimates take into account actual process parameters for these installations.

TABLE 2
Sintering plant measurements

| Method | Month 1 |
|---|---|
| Theoretical estimation | 32.7 |
| Lidar-based measurement | 31 |

TABLE 3
Blast furnace facility measurements

| Method | Month 1 |
|---|---|
| Theoretical estimation | 30.5 |
| Lidar-based measurement | 29.6 |

Again, a good agreement is found between the lidar-based measurements and the theoretical estimates.

The inventors have also tested a total-mass variation method, in which a total mass of particulates in volume V is computed by summing together elemental masses, for all the cells of the grid within volume V, each elemental mass being equal to the particulate density value at the cell considered multiplied by the cell volume. Then the total mass at time t+dt is compared to the total mass at time t, and the mass flux is deduced thereof. But this method turned out to give rather inaccurate results (far less accurate than the flux method above presented). A possible explanation for this being the limited temporal resolution, for complete volume scans (which take a rather long time to be carried on), and the fact that the primary quantity determined is a total mass, instead of a total flux.

Embodiments different than those described above, with reference to the figures, are possible without departing from the scope of the instant technology. For instance, instead of scanning in the PPI mode, then modifying the elevation and scanning again in the PPI mode, and so on, the overall scan could be achieved by scanning in the so-called Range Height Indicator (RHI) mode (in which the lidar holds its azimuth angle constant but varies its elevation angle, then modify its azimuth and scan again in the RHI mode and so on. Besides, the particulates flux may be determined for a control surface that is not enclosing completely (or almost completely) the open-air area to be monitored. Indeed, the instant method can also be applied beneficially for computing a flux of aerial particulates through another kind of control surface. For instance, through a control surface forming a boarder (located at a boarder) of a residential or other populated area (this control surface not necessarily enclosing completely a piece of land). The control surface could also extend over, or around an open-air area to be monitored, without necessarily completely covering up that area (not necessarily completely enclosing that area). Indeed, determining an outgoing aerial flux though a lateral surface extending around such an area already provides valuable information regarding emissions coming from that area.

1.-19. (canceled)

20. A method for determining a flux of aerial particulates, the method comprising:
s1) controlling a steerable lidar device so that the lidar device scans a control surface, by emitting several laser pulses directed along different emission axis (X_{j,k}) and acquiring corresponding back-scattered optical signals;
s2) processing the back-scattered optical signals to determine, along each emission axis, values of a particulate density (PM) and of a colinear wind speed (ωₘ) at different distances (dᵢ) from the lidar device,
s3) computing a particulates flux (φ) through the control surface based on the values of the particulate density (PM) and of the colinear wind speed (ωₘ).

21. The method as recited in claim 20 wherein the control surface extends over, or around, or over and around an open-air operation area (Zo), an aerial particulates emission from the open-air operation area (Zo) being determined by computing the flux (φ).

22. The method as recited in claim 21 wherein the control surface and the open-air operation area (Zo) form together a closed or mainly closed surface delineating a volume of air (V) that extends over the open-air operation area (Zo).

23. The method as recited in claim 21 wherein the control surface comprises a horizontal top surface and a vertical lateral surface surrounding the open-air operation area (Zo).

24. The method as recited in claim 20 wherein the lidar device is controlled, in step s1, so that at least some of the laser pulses emitted form a set of laser pulses emitted with respective azimuths (α₁, α₂, αᵢ) different from one another.

25. The method as recited in claim 25 wherein:
the set of laser pulses defines a first set of laser pulses, the laser pulses of the first set being emitted with a same, first elevation (β₁),
some others of the laser pulses emitted define a second set of laser pulses emitted with a same, second elevation (β₂) different from the first elevation (β₁), the lasers pulses of the second set being emitted with respective azimuths (α₁, α₂, αᵢ) different from one another.

26. The method as recited in claim 25 wherein step s3 comprises computing a value of a vertical component (u) of the wind speed (\vec{ω}) from at least: a first value (w_{m,1}) and a second value (w_{m,2}) of the colinear wind speed (wₘ), obtained respectively for the first elevation (β₁) and for the second elevation (β₂).

27. The method as recited in claim 26 wherein the value of the vertical component (u) of the wind speed (\vec{ω}) is computed by dividing:
the difference between the second value (ω_{m,2}) and the first value (ω_{m,1}) of the colinear wind speed (ωₘ),
by the difference between the second elevation (β₂) and the first elevation (β₁).

28. The method as recited in claim 23 wherein step s3 comprises computing a top particulate flux defined as a flux through the top surface of the control surface, the top particulate flux being computed from said values of the particulate density (PM), and from values of a vertical component (u) of the wind speed (\vec{ω}).

29. The method as recited in claim 24 wherein step s3 comprises computing an amplitude (v) or a direction of a horizontal component (\vec{v}) of the wind speed (\vec{ω}), from two or more values of the colinear wind speed (wₘ) obtained respectively for two or more of the azimuths.

30. The method as recited in claim 23 wherein step s3 comprises computing a lateral particulate flux defined as a flux through the lateral surface of the control surface(S), the lateral particulate flux being computed from the values of particulate density (PM) and from values of the amplitude (v) or of the direction of the horizontal component (\vec{v}) of the wind speed (\vec{ω}).

31. The method as recited in claim 20 wherein step s3 comprises the following steps:
building numerically a grid (G) comprising of cells (C_{i,j,k}) centered on the different emission axis (X_{j,k}) and located at the different distances (dᵢ) from the lidar device (2),
identifying frontier cells (C_{o,1}), which are the cells (C_{i,j,k}) of the grid (G) that intersect the control surface (S),
computing an elemental flux (φₗ) for each frontier cell (C_{o,l}), the elemental flux being a particulate flux through a portion (A) of control surface(S) intersected by the frontier cell considered, and
computing the particulate flux (φ) through the control surface(S) by summing the elemental particulate fluxes (φₗ) together.

32. The method as recited in claim 23 wherein, for the frontier cells (C_{o,l}) intersecting the lateral surface (S_{L}), each elemental flux, noted φₗ, is computed according to equation eqn 1 below:
$${φ}_{l} = {PM}_{l} \cdot A \cdot {v}_{l} \cdot cos ( {θ}_{l} ) \qquad ( eqn 1 )$$
Where:
PM_{I} is the value of the particulate density in the frontier cell (C_{o,l}) considered,
A is the area of the portion of the lateral surface (S_{L}) that is intersected by the frontier cell (C_{o,l}) considered,
vₗ is the amplitude of the horizontal component of the wind speed at the frontier cell (C_{o,l}) considered,
qₗ is the angle between: a vector (\vec{n}) perpendicular to the lateral surface (S_{L}) at the frontier cell (C_{o,l}) considered, and the horizontal component (\vec{v}) of the wind speed (\vec{ω}).

33. The method as recited in claim 20 further comprising a preliminary calibration step including:
controlling the lidar device to acquire a calibration back-scattered optical signal, for a given fixed emission axis passing at a fixed measurement position, several times successively at different instants, and acquiring jointly values of the particulate density, at said position, measured by a particulate sensor,
processing each calibration back-scattered optical signal, to determine a value of a back-scattered coefficient βₒₚₜ, at said measurement position,
temporally aligning the set of values of βₒₚₜ at said instants, with the set of values of the particulate density measured by the particulate sensor,
determining a numerical relationship relating βₒₚₜ to the particulate density, by correlating the set of values of βₒₚₜ and the set of values of the particulate density.

34. The method as recited in claim 21 wherein the open-air operation area (Zo) includes or is part of an industrial facility.

35. The method as recited in claim 21 wherein the open-air operation area (Zo) encompasses a mineral yard or an open pit mine.

36. An electronic device configured to execute the following steps:
s1) controlling a steerable lidar device so that the lidar device scans a control surface(S), by emitting several laser pulses directed along different emission axis (X_{j,k}) and acquiring corresponding back-scattered optical signals;
s2′) receiving, from the lidar device:
values, along each emission axis, of a particulate density (PM) and of a colinear wind speed (ωₘ) at different distances (dᵢ) from the lidar device, determined by the lidar device from said back-scattered optical signals; or
data, comprising the back-scattered optical signals or derived from the back-scattered optical signals, suitable to determine values of the particulate density (PM) and of the colinear wind speed (ωₘ), along each emission axis, at different distances (dᵢ) from the lidar device, and
s3) computing a particulate flux (φ) through the control surface(S) based on said values of the particulate density (PM) and of the colinear wind speed (ωₘ).

37. A system comprising a steerable lidar device and a processing device, configured to execute the following steps:
s10) scanning, by the steerable lidar device, a control surface, by emitting several laser pulses directed along different emission axis (X_{j,k}) and acquiring corresponding back-scattered optical signals;
s2) processing the back-scattered optical signals, by the processing device or the steerable lidar device (2), to determine, along each emission axis, values of a particulate density (PM) and of a colinear wind speed (ωₘ) at different distances (dᵢ) from the lidar device (2),
s3) computing a particulates flux (φ) through the control surface based on the values of the particulate density (PM) and of the colinear wind speed (ωₘ).

38. Computer program comprising instructions, whose execution on a computer device connected to a steerable lidar device makes the computer device execute the following steps:
s1) controlling the steerable lidar device so that the lidar device scans a control surface, by emitting several laser pulses directed along different emission axis (X_{j,k}) and acquiring corresponding back-scattered optical signals;
s2′) receiving, from the lidar device:
values, along each emission axis, of a particulate density (PM) and of a colinear wind speed (ωₘ) at different distances (dᵢ) from the lidar device, determined by the lidar device from said back-scattered optical signals; or
data, comprising the back-scattered optical signals or derived from the back-scattered optical signals, suitable to determine values of the particulate density (PM) and of the colinear wind speed (ωₘ) along each emission axis, at different distances (dᵢ) from the lidar device,
s3) computing a particulate flux (φ) through the control surface based on the values of the particulate density (PM) and of the colinear wind speed (ωₘ).
